(19) United States
(12) Patent Application Publication
(10) Pub. No.: US 2017/0046632 A1
(43) Pub. Date: Feb. 16, 2017

(54) SYSTEM AND METHOD FOR PROCESSING TRAVEL RESERVATIONS MADE OUTSIDE OF COMPANY TRAVEL POLICY

(71) Applicant: Traxo, Inc., Dallas, TX (US)

(72) Inventors: Andres Fabris, Dallas, TX (US); Richard Pendergast, Gainesville, TX (US)

(21) Appl. No.: 14/822,498

(22) Filed: Aug. 10, 2015

(51) Int. Cl. G06Q 10/02; G06Q 50/12

(52) U.S. Cl. CPC G06Q 10/02; G06Q 50/12

(57) ABSTRACT

A system performs a method for processing travel reservations. The method includes receiving an indication of a hotel reservation made by an employee of a company. The method also includes determining whether the hotel reservation complies with a travel policy of the company. The method further includes determining whether the hotel reservation meets an exception to the travel policy. The method still further includes determining whether the hotel reservation is cancelable. In addition, the method includes, upon a determination that the hotel reservation is cancelable, automatically canceling the hotel reservation or alerting the employee so the employee may cancel the hotel reservation, and determining a list of recommended hotels that are within the travel policy for presentation to the employee.

### TECHNICAL FIELD

The present disclosure relates to a system and method for identifying, processing, and handling travel reservations that are made outside of a company travel policy.

### BACKGROUND

Companies that have employees who travel for business often implement a company travel policy in order to maintain consistency in travel and to keep costs at a reasonable level. Due to the proliferation of travel booking sites on the Internet, it is easier than ever for a person (e.g., an employee of the company) to book travel reservations independently. However, many of the travel booking sites may not be included in a company travel policy. Likewise, many travel providers (e.g., airlines, hotels, car rental agencies, etc.) or their standard pricing rates may not be included in the company travel policy. Thus, it would be helpful to identify and handle travel reservations that are booked by an employee outside of the company travel policy without restricting the employee to specific booking agents or booking websites.

### SUMMARY

This disclosure provides a system and method for identifying, processing, and handling travel reservations that are made outside of a company travel policy.

In a first embodiment, a method is provided. The method includes receiving an indication of a hotel reservation made by an employee of a company. The method also includes determining whether the hotel reservation complies with a travel policy of the company. The method further includes determining whether the hotel reservation meets an exception to the travel policy. The method still further includes determining whether the hotel reservation is cancelable. In addition, the method includes, upon a determination that the hotel reservation is cancelable, automatically canceling the hotel reservation or alerting the employee so the employee may cancel the hotel reservation, and determining a list of recommended hotels that are within the travel policy for presentation to the employee.

In a second embodiment, a system is provided. The system includes at least one memory and at least one processor coupled to the at least one memory. The at least one processor is configured to receive an indication of a hotel reservation made by an employee of a company, determine whether the hotel reservation complies with a travel policy of the company, determine whether the hotel reservation meets an exception to the travel policy, determine whether the hotel reservation is cancelable, and upon a determination that the hotel reservation is cancelable, automatically cancel the hotel reservation or alert the employee so the employee may cancel the hotel reservation, and determine a list of recommended hotels that are within the travel policy for presentation to the employee.

In a third embodiment, a non-transitory computer readable medium is provided. The non-transitory computer readable medium embodies a computer program comprising computer readable program code for receiving an indication of a hotel reservation made by an employee of a company, determining whether the hotel reservation complies with a travel policy of the company, determining whether the hotel reservation meets an exception to the travel policy, determining whether the hotel reservation is cancelable, and upon a determination that the hotel reservation is cancelable, automatically canceling the hotel reservation or alerting the employee so the employee may cancel the hotel reservation, and determining a list of recommended hotels that are within the travel policy for presentation to the employee.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, in which:

FIG. 1 illustrates an example system for performing all or a portion of any of the methods or processes described in this disclosure;

FIG. 2 illustrates an example computing device for performing all or a portion of any of the methods or processes described in this disclosure; and

FIG. 3 illustrates an example method for identifying, processing, and handling travel reservations in accordance with this disclosure.

### DETAILED DESCRIPTION

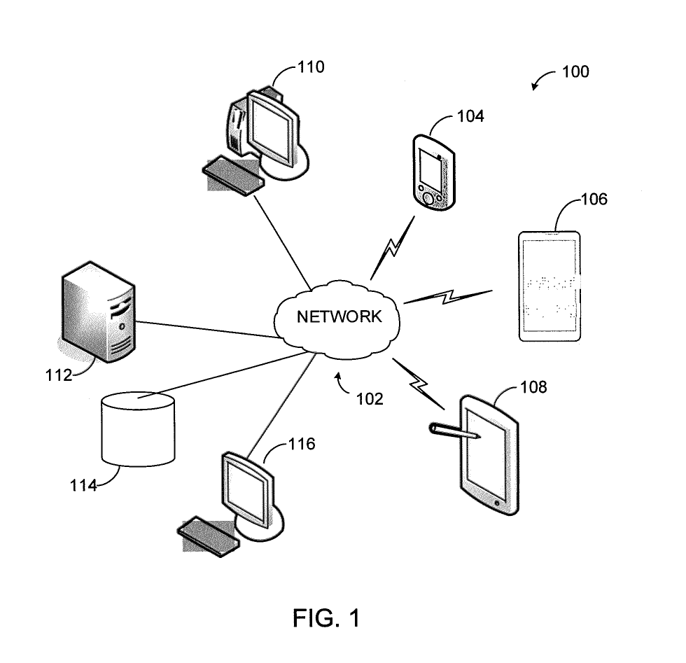

FIGS. 1 through 3, discussed below, and the various embodiments used to describe the principles of the present disclosure are by way of illustration only and should not be construed in any way to limit the scope of the disclosure. Those skilled in the art will understand that the principles of the disclosure may be implemented in any suitably arranged system.

Some companies require that business travel for their employees be booked in accordance with a company travel policy. For example, the travel policy could require that the employee book travel using a predetermined travel website or travel agency. However, an employee may sometimes book business travel outside of policy in order to get affinity points, or to book with a provider that is not a preferred provider in the travel policy, or even to get a better rate than is available using the reservation tools available in the travel policy.

When a hotel is booked out of policy, there is often a company interest in rebooking the employee with another hotel that is in policy. For example, the travel policy may include negotiated hotel rates that are less than the rate available when booked out of policy. Even if an out-of-policy hotel rate is the same as or less than the negotiated in-policy rate, the company may still want the reservation booked in policy in order to achieve or maintain hotel-night volume or qualify for other incentives with a preferred provider.

Currently, companies do not have a convenient, reliable tool to determine when their employees make travel reservations, such as a hotel, airplane, or car rental reservation, outside of the company's official travel policy. Instead, a company typically learns about the reservation booked out of policy when the employee submits the expense for the travel for reimbursement. At that point, it is too late for the company to take any corrective action to get the employee to comply with the travel policy.

To address these issues, embodiments of the present disclosure provide a system and method for identifying, processing, and handling travel reservations that are made outside of a company travel policy. In particular embodiments, a hotel reservation that is made outside of the company travel policy is evaluated to determine if the reservation is cancelable. The evaluation can be performed by intelligently identifying and parsing cancellation information from a hotel reservation record.

As used throughout this disclosure, the term “in policy” refers to a reservation that is made in compliance with the rules of a company's travel policy. In contrast, the term “out of policy” indicates that one or more aspects of the reservation do not fully comply with the rules of the company's travel policy. Also, while the term “employee” may refer to an actual employee of a company, this disclosure is not limited thereto. As used herein, “employee” may also refer to a contractor, freelancer, vendor, supplier, temporary worker, or any other individual or group that has an association with a company and may book travel related to its association with the company, where such travel may be required or preferred to be in policy.

FIG. 1 illustrates an example system 100 for performing all or a portion of any of the methods or processes described in this disclosure. For example, all or portions of the system 100 can be used for identifying, processing, and handling travel reservations that are made outside of a company travel policy. The embodiment illustrated in FIG. 1 is for illustration only. Other embodiments could be used without departing from the scope of this disclosure.

As shown in FIG. 1, the system 100 includes a network 102. The network 102 generally represents a communication network or combination of communication networks facilitating communication between different devices or systems. Each network 102 provides any suitable communication links, such as wired, wireless, fiber optic links, or the like. In particular embodiments, the network 102 includes a combination of networks, such as the Internet, one or more cellular communication networks, and one or more local or wide area networks (which could support wired or wireless communications).

Multiple end user devices 104-110 communicate via the network 102. The user devices 104-110 generally denote devices used for making, receiving, processing, or interpreting travel reservation information as described in greater detail below. The user devices 104-110 include fixed or mobile devices that communicate over wired, wireless, or other connections with at least one of the networks 102.

In this example, the user devices 104-110 include a personal digital assistant 104, a smartphone 106, a tablet computer 108, and a desktop or laptop computer 110. Any other or additional user devices can be used in the system 100, and the system 100 can support interaction with any number of user devices.

One or more servers 112 also communicate over the network 102. Each server 112 represents a computing device that processes information associated with one or more travel reservation records. Information associated with the operations of the server 112 is stored in one or more related databases 114. For example, each server 112 receives, updates, or processes information associated with one or more travel reservation records, such as a hotel reservation, an airplane reservation, or a car rental reservation. Different information or additional information can also be provided by each server 112. Each server 112 includes any suitable structure for providing information and interacting with user devices. The database 114 includes any suitable structure for storing information and for facilitating retrieval of information.

One or more operator stations 116 are capable of interacting with the server 112. For example, an operator station 116 allows an operator to make, receive, process, review, or interpret travel reservation information as described in greater detail below. Each operator station 116 includes any suitable structure supporting interaction with a server, such as a desktop computer, laptop computer, dumb terminal, or mobile device.

As described herein, each user device 104-110 and operator station 116 executes an application or accesses an application executed by the server 112. The application allows a user to interact with, receive information from, and provide information to, the server 112. For example, the server 112 can receive requests from the user devices 104-110 or operator station 116 and, in response to receiving requests from the user devices 104-110 or operator station 116, provides information from the database 114. Other operations supported by the application are described herein.

Although FIG. 1 illustrates one example of a system 100 for identifying, processing, and handling travel reservations, various changes may be made to FIG. 1. For example, various components in FIG. 1 could be combined, further subdivided, rearranged, or omitted and additional components could be added according to particular needs.

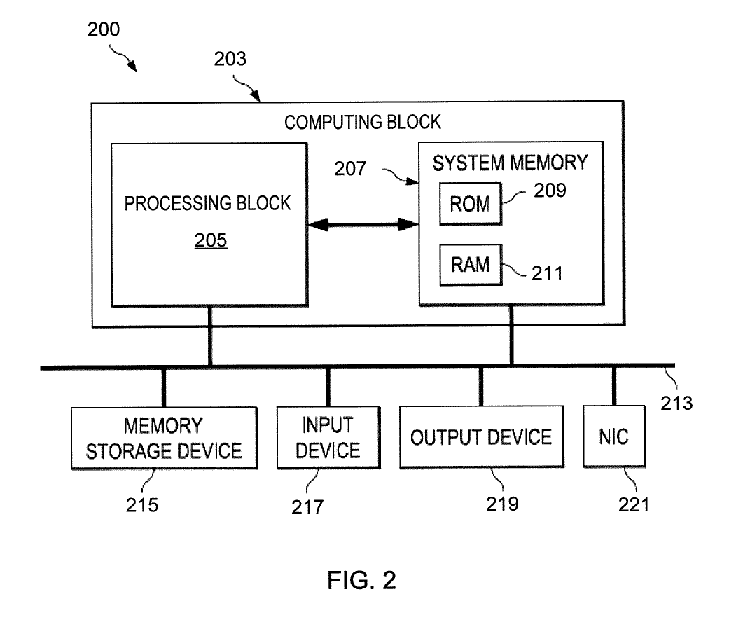

FIG. 2 illustrates an example of a computing device 200 for performing all or a portion of any of the methods or processes described herein. The computing device 200 can be used in the system 100. For example, the computing device 200 can represent any of the components 104-112 and 116 in FIG. 1. In general, the methods disclosed herein may be performed using a parallel computing platform comprising a plurality of computing nodes, such as a data center that includes multiple servers connected by a network. Each computing node may be represented by one computing device 200. The parallel computing platform may have as few or as many computing nodes (e.g., computing devices 200) as needed to perform the disclosed methods.

As shown in FIG. 2, the computing device 200 includes a computing block 203 with a processing block 205 and a system memory 207. The processing block 205 may be any type of programmable electronic device for executing software instructions, but will conventionally be one or more microprocessors. The system memory 207 may include both a read-only memory (ROM) 209 and a random access memory (RAM) 211. As will be appreciated by those of skill in the art, both the read-only memory 209 and the random access memory 211 may store software instructions for execution by the processing block 205.

The processing block 205 and the system memory 207 are connected, either directly or indirectly, through a bus 213 or alternate communication structure, to one or more peripheral devices. For example, the processing block 205 or the system memory 207 may be directly or indirectly connected to one or more additional memory storage devices 215. The memory storage devices 215 may include, for example, a “hard” magnetic disk drive, a solid state disk drive, an optical disk drive, and a removable disk drive. The processing block 205 and the system memory 207 also may be directly or indirectly connected to one or more input devices 217 and one or more output devices 219. The input devices 217 may include, for example, a keyboard, a pointing device (such as a mouse, touchpad, stylus, trackball, or joystick), a touch screen, a scanner, a camera, and a microphone. The output devices 219 may include, for example, a display device, a printer and speakers. Such a display device may be configured to display video images. With various examples of the computing device 200, one or more of the peripheral devices 215-219 may be internally housed with the computing block 203. Alternately, one or more of the peripheral devices 215-219 may be external to the housing for the computing block 203 and connected to the bus 213 through, for example, a Universal Serial Bus (USB) connection or a digital visual interface (DVI) connection.

With some implementations, the computing block 203 may also be directly or indirectly connected to one or more network interfaces cards (NIC) 221, for communicating with other devices making up a network. The network interface cards 221 translate data and control signals from the computing block 203 into network messages according to one or more communication protocols, such as the transmission control protocol (TCP) and the Internet protocol (IP). Also, the network interface cards 221 may employ any suitable connection agent (or combination of agents) for connecting to a network, including, for example, a wireless transceiver, a modem, or an Ethernet connection.

It should be appreciated that the computing device 200 is illustrated as an example only, and it not intended to be limiting. Various embodiments of this disclosure may be implemented using one or more computing devices that include the components of the computing device 200 illustrated in FIG. 2, or which include an alternate combination of components, including components that are not shown in FIG. 2. For example, various embodiments may be implemented using a multi-processor computer, a plurality of single and/or multiprocessor computers arranged into a network, or some combination of both.

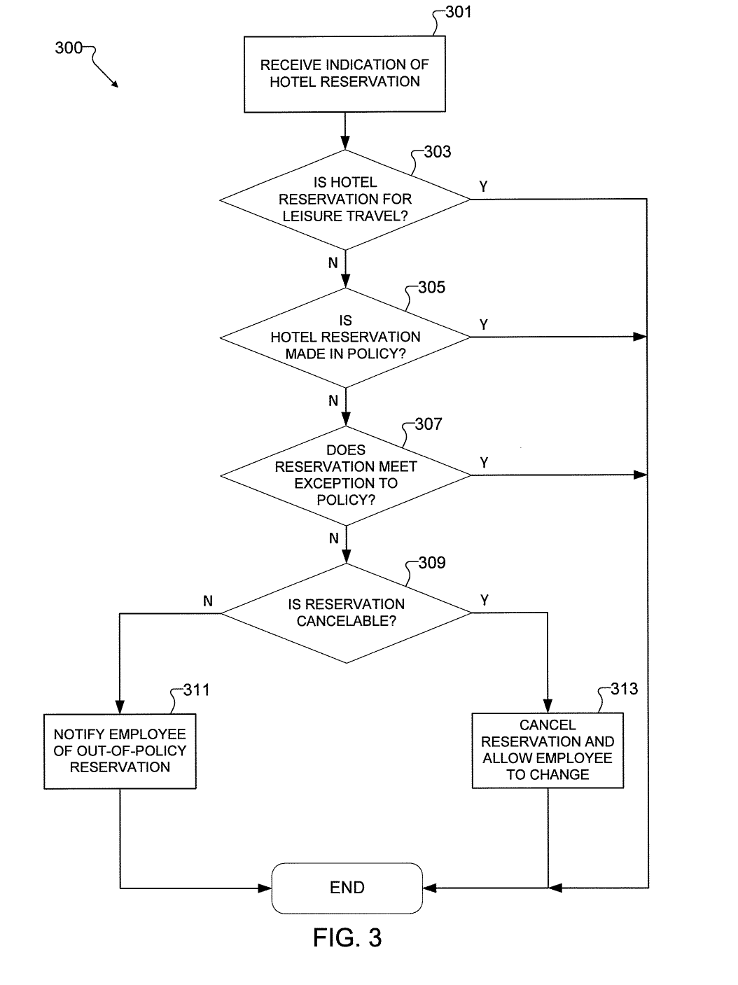

FIG. 3 illustrates an example method 300 for identifying, processing, and handling travel reservations in accordance with this disclosure. While the method 300 is described with respect to hotel reservations, it will be understood that the same or a similar method may be used for other types of lodging (e.g., motels, resorts, vacation rentals, inns, etc.), and travel services other than lodging (e.g., air travel, car rental, travel activities, etc.). The method 300 may be performed by one or more components of the system 100 of FIG. 1, which may include a computing device, such as the computing device 200 of FIG. 2.

The method 300 starts at operation 301, where the system receives an indication of a hotel reservation made by an employee of a company. This may include a component of the system (e.g., an email server at the company) intercepting and identifying an email sent to the employee's work email address that includes hotel reservation information. The system can determine that the email contains hotel reservation information by using a keyword based filter that searches for specific text in the email (e.g., “check-in date” or “room type” or “Marriott”). In some embodiments, the system 100 can determine that the email contains hotel reservation information based on the domain or email address of the sender (e.g., an email from reservations@HotelChain.com).

Depending on the embodiment, an indication of a hotel reservation may additionally or alternatively be received from a source other than an email. For example, in some embodiments, a system receives an indication of a reservation (e.g., reservation information) through an API (application programming interface) or by aggregating the reservation from data feeds or websites associated with a travel supplier, with an on-line travel service, or with a traditional travel agency. In some embodiments, reservation information could be pulled from an employee's electronic work calendar. Also, in some embodiments, a reservation confirmation could be received via text message.

Later at operation 303, the system determines if the hotel reservation made by the employee is for leisure travel. In most cases, a reservation for an employee's leisure trip that is sent to the employee's work email address would not need to be in compliance with the company travel policy. The system may automatically detect leisure travel by examining the travel dates associated with the reservation; travel that occurs during the weekend only, or during a holiday or a scheduled vacation, may be considered leisure travel. The system may also detect leisure travel by recognizing non-employee names (e.g., family members of the employee) on the travel itinerary, or by determining travel to destinations that are not within the travel destinations allowed by the company travel policy.

In some embodiments, if the system is not able to determine if a hotel reservation is for business or leisure travel, the system may send a notification or inquiry (e.g., an email or a web link) to the employee requesting the employee to verify if the reservation is for business travel or leisure travel.

If it is determined that the hotel reservation made by the employee is for leisure travel, then no further action is required, and the method ends.

Alternatively, if it is determined that the hotel reservation made by the employee is not for leisure travel (i.e., for business travel), then at operation 305, the system determines if the hotel reservation made by the employee is in policy. Reservations made in policy using a preferred booking tool or agency can be determined through examination of the electronic reservation record (e.g., the received email). For example, the reservation record may have a predetermined flag, text, symbol, or other suitable indicator that indicates that the reservation was made in compliance with the company's travel policy. As a particular example, the words “Complies with company travel policy” or a similar string may appear somewhere within the reservation record. As another example, any reservation record that is generated by a preferred travel engine may be deemed to be in policy. Thus, any emailed reservation record that is sent from one or more predetermined email addresses or domains (e.g., reservations@preferredtravelengine.com) may be considered to be in policy.

In contrast, reservation emails from some email addresses or domains may be suggestive of a reservation that is made out of policy. For example, when a company travel policy requires that reservations be made through a travel reservation engine, an email from a particular hotel chain directly to an employee (e.g., an email from reservations@HotelChain.com to joeemployee@company.com) may indicate that a reservation was booked out of policy. Such incoming emails may be intercepted by the company's email server for further analysis to determine if the reservation is in policy.

If it is determined that the hotel reservation made by the employee is in policy, then no further action is required, and the method ends.

Alternatively, if it is determined that the hotel reservation made by the employee is not in policy, then at operation 307, the system determines whether or not the hotel reservation meets an exception to the travel policy.

In some exception cases, it may be acceptable for the employee to book a hotel reservation outside of the company travel policy. To identify such an exception, the system may send a notification (e.g., an email or a web link) to the employee indicating that the hotel reservation was made out of policy. The notification may ask the employee if there is a reason for the exception to the policy.

As an example of a travel policy exception, a lower “conference rate” for a hotel stay associated with a conference at a hotel may only be available by booking directly with the hotel. In such a case, the lower rate may be acceptable to the company even though it was booked outside of policy.

In some embodiments, if a hotel is booked out of policy, the system may determine if the booked hotel rate is less than or equal to the hotel rate available within the policy. For example, after determining the existence of the out-of-policy hotel reservation, the system may automatically search for the same hotel and same dates using one or more in-policy travel booking tools to determine the in-policy rate. If the in-policy rate is greater than the out-of-policy rate booked by the employee, the system may take no action, or the system may simply send a reminder to the employee to use the in-policy travel tools when booking future travel.

As another example of a travel policy exception, the system may determine that there are no hotel properties or available rooms at a particular destination that meet policy requirements. Of course, in some circumstances, the system may determine that no in-policy hotel properties or rooms are available at the destination due to a late date of booking by the employee. In such a case, the system may send a notification to the employee reminding the employee to book earlier to avoid having to book out-of-policy travel.

If it is determined that the hotel reservation made by the employee meets an exception to the travel policy, then no further action is required, and the method ends.

Alternatively, if it is determined that the hotel reservation made by the employee does not meet an exception to the travel policy, then at operation 309, the system determines whether or not the hotel reservation made by the employee is fully cancelable.

An important factor in determining whether or not to rebook a hotel reservation made out of policy is whether or not the hotel reservation is cancelable. For example, when a pre-paid reservation is made at a first hotel, and the reservation is not cancelable, the company often will not want to rebook at a different hotel and lose a prepayment or be subject to a penalty at the first hotel. However, if the reservation at the first hotel is fully cancelable without penalty and with a refund of any prepayment, then the company may want to cancel the reservation and book a new reservation that is in policy, either at the same hotel or at a different hotel.

To determine whether or not the hotel reservation made by the employee is fully cancelable, the system may examine and parse information in the reservation record (e.g., text within the body of an email to the employee, a document attached to the email, a website screen shot, a fax, or any other suitable record). For example, a parsing engine in the system may parse the reservation record to determine the existence of one or more text strings or keywords associated with a cancellation policy of the hotel reservation. Representative text strings may include “Cancelable without penalty”, “Cancelable without penalty at least seven days in advance”, “Cancellation subject to a one night penalty”, or “Deposit is not refundable.” Then, the system interprets the identified text strings or keywords to determine the cancellation policy. For example, the system may determine that the reservation is fully cancelable without penalty, fully cancelable subject to a date restriction, cancelable with a penalty, not cancelable/refundable, or any other suitable form.

In some embodiments, the system can identify, parse, and process cancellation policies in languages other than English. In such embodiments, the system may first identify what language is represented in the reservation record, and then once the language is identified, the system performs a cancellation policy processing routine associated with that language.

In some embodiments, the system can process cancellation-related information in formats different than standard U.S. format. For example, while most reservation records include date information that is stored, recorded, or presented in U.S. date format (e.g., “mm-dd-yyyy”), some reservation records include dates that are in other formats, such as European format (e.g., “dd.mm.yyyy”). To address this, the system can identify and process dates recorded in European format or other formats. In some embodiments, the system may use location or time zone information associated with the reservation record to identify information that is recorded in non-U.S. format.

In some embodiments, if the cancellation policy cannot be determined the by parsing engine, the system generates an exception message, such as “cancellation policy not understood”, “cancellation information not available”, or another similar indication. In such embodiments, the exception message may be shown on a computer display or in a report, and a user of the system (e.g., an accounting agent responsible for reimbursing employee travel expenses) may review the message and manually check the reservation record for a cancellation policy.

If it is determined that the hotel reservation booked by the employee is non-cancelable or non-refundable, then at operation 311, the system can send a notification to the employee that the employee booked a non-cancelable hotel reservation that is outside the company travel policy. In some embodiments, the system may require that the employee reimburse the company for the difference between the cost of the hotel stay that is booked out of policy and the cost of a stay (at the same hotel or a comparable hotel) that is booked in policy.

Alternatively, if it is determined that the hotel reservation booked by the employee is cancelable or refundable, then at operation 313, the system gives the employee an opportunity to review and change the reservation. For example, the system can send a notification to the employee informing the employee of the out-of-policy reservation and instructing the employee to rebook the reservation in accordance with the travel policy. The notification may include one or more recommended in-policy options for the employee to choose from. The recommendations could be based on dates of travel, location of travel, price per room night, star rating of the reserved property, hotel reviews and quality ratings, and the like. The recommended in-policy options may be determined by an automated travel booking engine, by a travel agent, or by another suitable travel booking method. For example, the recommended in-policy options could be determined by automatically searching one or more hotels in the geographical area (which may include the booked hotel) using the same dates using in-policy tools to determine one or more in-policy rates.

To perform a search of hotels in a geographical area, the system could identify the geographical location of the hotel booked out of policy, and search for hotels that are within a predetermined radius of the booked hotel. The predetermined radius could be set according to the travel policy. In some embodiments, the predetermined radius may vary depending on location. For example, in dense urban areas, the predetermined radius of the search may be smaller than the predetermined radius for a search in a more rural area. In some embodiments, the search of hotels may be performed in accordance with one or more of the embodiments disclosed in U.S. patent application Ser. No. 14/599,956, filed Jan. 19, 2015, the contents of which are incorporated herein by reference. For these embodiments, the system is configured to parse out not only the cancellation policy of the reservation, but also the price, location, travel dates, hotel brand, star rating, or any other details (e.g., room type) of the reservation in order to do a comparative search.

Once the search is performed and one or more alternative hotels are identified, the system may present the employee with a list of the alternative hotels. The employee can review the list and determine whether or not one of the alternative hotels is acceptable for rebooking. In some embodiments, when the employee selects one of the alternative hotels, the system automatically cancels the hotel reservation booked out of policy and makes a new reservation for the selected alternative hotel. In other embodiments, the employee is responsible for canceling the hotel reservation booked out of policy and making the new reservation for the selected alternative hotel. In some embodiments, the employee may be allowed to decline the recommended in-policy reservation options.

In some embodiments, the hotel property may be in policy, but the hotel rate booked by the employee may be greater than the negotiated in-policy rate. In such a case, the system may send a notification to the employee that the booked rate is too high, and may direct the employee to cancel the reservation and book the hotel at the negotiated in-policy rate.

If a hotel reservation booked by an employee is cancelable or refundable within a certain timeframe, the system may send a notification to the employee instructing the employee to cancel the reservation within the timeframe and then book a hotel reservation using the in-policy travel guidelines or tools.

In some embodiments, the notifications sent to the employee may be in the form of one or more emails sent to the employee's email account. In other embodiments, one or more notifications may occur through an instant messaging channel, a corporate internal communication service, or using any other suitable method of communication.

Although FIG. 3 illustrates one example of a method 300 for identifying, processing, and handling travel reservations, various changes may be made to FIG. 3. For example, various operations shown in FIG. 3 could overlap, occur in parallel, occur in a different order, or occur multiple times. Moreover, some operations could be combined or removed and additional operations could be added.

Although embodiments of this disclosure have been described in the context of an employee of a company, this disclosure is not limited thereto. For example, a wide variety of travelers (not just company employees) may benefit from automatically knowing if a hotel's policy allowed cancellations, and if so, what nearby hotels could offer them savings. Thus, the concepts and methods described herein can be extended broadly to all travelers in general.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or a combination of hardware and software/firmware. The functionality associated with any particular controller may be centralized or distributed, whether locally or remotely. The phrase “at least one of,” when used with a list of items, means that different combinations of the listed items may be used, and only one item in the list may be needed. For example, “at least one of: A, B, and C” includes any of the o following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method by at least one processor, the method comprising:
receiving an indication of a hotel reservation made by an employee of a company;
determining whether the hotel reservation complies with a travel policy of the company;
determining whether the hotel reservation meets an exception to the travel policy;
determining whether the hotel reservation is cancelable; and
upon a determination that the hotel reservation is cancelable, automatically canceling the hotel reservation or alerting the employee so the employee may cancel the hotel reservation, and determining a list of recommended hotels that are within the travel policy for presentation to the employee.

2. The method of claim 1, wherein receiving an indication of a hotel reservation comprises receiving, by an email server, an email sent to the employee's work email address that includes hotel reservation information.

3. The method of claim 1, wherein determining whether the hotel reservation complies with a travel policy of the company comprises at least one of:
determining whether a record of the hotel reservation comprises a flag or text indicating that the reservation complies with the travel policy; or determining whether an email having the record of the hotel reservation was sent from an email address or email domain that is associated with the travel policy.

4. The method of claim 1, wherein determining whether the hotel reservation meets an exception to the travel policy comprises at least one of:
determining whether the hotel reservation is associated with non-business travel; or
determining whether a reserved hotel rate in the hotel reservation is less than or equal to a hotel rate available within the travel policy.

5. The method of claim 1, wherein determining whether the hotel reservation is cancelable comprises:
parsing a record of the hotel reservation to determine whether the record includes one or more text strings or keywords associated with a cancellation policy; and
interpreting the one or more text strings or keywords to determine the cancellation policy.

6. The method of claim 1, wherein determining a list of recommended hotels that are within the travel policy comprises searching a database of hotels to determine hotels that (i) are within a predetermined geographical distance of the hotel associated with the hotel reservation, and (ii) have availability during a time period associated with the hotel reservation.

7. The method of claim 6, further comprising:
presenting the list of recommended hotels to the employee;
receiving a selection by the employee of a hotel among the list of recommended hotels; and
making a second hotel reservation at the selected hotel.

8. A system comprising:
at least one memory; and
at least one processor coupled to the at least one memory, the at least one processor configured to:
receive an indication of a hotel reservation made by an employee of a company;
determine whether the hotel reservation complies with a travel policy of the company;
determine whether the hotel reservation meets an exception to the travel policy;
determine whether the hotel reservation is cancelable; and
upon a determination that the hotel reservation is cancelable, automatically cancel the hotel reservation or alert the employee so the employee may cancel the hotel reservation, and determine a list of recommended hotels that are within the travel policy for presentation to the employee.

9. The system of claim 8, wherein to receive an indication of a hotel reservation, the at least one processor is configured to receive, an email sent to the employee's work email address that includes hotel reservation information.

10. The system of claim 8, wherein to determine whether the hotel reservation complies with a travel policy of the company, the at least one processor is configured to at least one of:
determine whether a record of the hotel reservation comprises a flag or text indicating that the reservation complies with the travel policy; or
determine whether an email having the record of the hotel reservation was sent from an email address or email domain that is associated with the travel policy.

11. The system of claim 8, wherein to determine whether the hotel reservation meets an exception to the travel policy, the at least one processor is configured to at least one of:
determine whether the hotel reservation is associated with non-business travel; or
determine whether a reserved hotel rate in the hotel reservation is less than or equal to a hotel rate available within the travel policy.

12. The system of claim 8, wherein to determine whether the hotel reservation is cancelable, the at least one processor is configured to:
parse a record of the hotel reservation to determine whether the record includes one or more text strings or keywords associated with a cancellation policy; and
interpret the one or more text strings or keywords to determine the cancellation policy.

13. The system of claim 8, wherein to determine a list of recommended hotels that are within the travel policy, the at least one processor is configured to search a database of hotels to determine hotels that (i) are within a predetermined geographical distance of the hotel associated with the hotel reservation, and (ii) have availability during a time period associated with the hotel reservation.

14. The system of claim 13, wherein the at least one processor is further configured to:
present the list of recommended hotels to the employee;
receive a selection by the employee of a hotel among the list of recommended hotels; and
make a second hotel reservation at the selected hotel.

15. A non-transitory computer readable medium embodying a computer program, the computer program comprising computer readable program code for:
receiving an indication of a hotel reservation made by an employee of a company;
determining whether the hotel reservation complies with a travel policy of the company;
determining whether the hotel reservation meets an exception to the travel policy;
determining whether the hotel reservation is cancelable; and
upon a determination that the hotel reservation is cancelable, automatically canceling the hotel reservation or alerting the employee so the employee may cancel the hotel reservation, and determining a list of recommended hotels that are within the travel policy for presentation to the employee.

16. The non-transitory computer readable medium of claim 15, wherein receiving an indication of a hotel reservation comprises receiving, by an email server, an email sent to the employee's work email address that includes hotel reservation information.

17. The non-transitory computer readable medium of claim 15, wherein determining whether the hotel reservation complies with a travel policy of the company comprises at least one of:
determining whether a record of the hotel reservation comprises a flag or text indicating that the reservation complies with the travel policy; or
determining whether an email having the record of the hotel reservation was sent from an email address or email domain that is associated with the travel policy.

18. The non-transitory computer readable medium of claim 15, wherein determining whether the hotel reservation meets an exception to the travel policy comprises at least one of:
determining whether the hotel reservation is associated with non-business travel; or
determining whether a reserved hotel rate in the hotel reservation is less than or equal to a hotel rate available within the travel policy.

19. The non-transitory computer readable medium of claim 15, wherein determining whether the hotel reservation is cancelable comprises:
parsing a record of the hotel reservation to determine whether the record includes one or more text strings or keywords associated with a cancellation policy; and
interpreting the one or more text strings or keywords to determine the cancellation policy.

20. The non-transitory computer readable medium of claim 15, wherein determining a list of recommended hotels that are within the travel policy comprises searching a database of hotels to determine hotels that (i) are within a predetermined geographical distance of the hotel associated with the hotel reservation, and (ii) have availability during a time period associated with the hotel reservation.
